(19) United States
(12) Patent Application Publication
(10) Pub. No.: US 2003/0103778 A1
(43) Pub. Date: Jun. 5, 2003

(54) Power control for a xerographic fusing apparatus

(75) Inventors: David J. Meads, St. Albans (GB); Mark W. Horobin, Welwyn Garden City (GB)

Correspondence Address: Patent Documentation Center, Xerox Corporation, Xerox Sq., 20th Floor, 100 Clinton Avenue South, Rochester, NY, 14644, US

(73) Assignee: Xerox Corporation

(21) Appl. No.: 09/998,337

(22) Filed: Dec. 3, 2001

(51) Int. Cl. G03G 15/00

(52) U.S. Cl. 399/88

(57) ABSTRACT

A fusing apparatus for xerographic printing includes a fuser roll with two parallel lamps, or heating elements, therein. At power-up, power is applied to each lamp in a stair-step fashion, in which incremental increases in applied power for each lamp are staggered in time. The incremental increases are made by adding half-cycles to an alternating current applied to each lamp.

### CROSS-REFERENCE TO RELATED APPLICATION

Cross-reference is made to co-pending application U.S. Ser. No. 09/891,783, filed Jun. 26, 2001, entitled “Method of Operating a Xerographic Fusing Apparatus with Multiple Heating Elements.”

### FIELD OF THE INVENTION

The present invention relates to a fusing apparatus, as used in electrostatographic printing, such as xerographic printing or copying, and methods of operating thereof.

### BACKGROUND OF THE INVENTION

In electrostatographic printing, commonly known as xerographic or printing or copying, an important process step is known as “fusing.” In the fusing step of the xerographic process, dry marking material, such as toner, which has been placed in imagewise fashion on an imaging substrate, such as a sheet of paper, is subjected to heat and/or pressure in order to melt or otherwise fuse the toner permanently on the substrate. In this way, durable, non-smudging images are rendered on the substrates.

Currently, the most common design of a fusing apparatus as used in commercial printers includes two rolls, typically called a fuser roll and a pressure roll, forming a nip therebetween for the passage of the substrate therethrough. Typically, the fuser roll further includes, disposed on the interior thereof, one or more heating elements, which radiate heat in response to a current being passed therethrough. The heat from the heating elements passes through the surface of the fuser roll, which in turn contacts the side of the substrate having the image to be fused, so that a combination of heat and pressure successfully fuses the image.

A design consideration which has recently become important in the office equipment industry is the avoidance of “flicker” with regard to a power system associated with the printing apparatus. “Anti-flicker” mandates, which basically require that the power consumption of the machine as a whole does not affect the behavior of other equipment, such as fluorescent lighting, within the same building, are of concern in many countries.

### DESCRIPTION OF THE PRIOR ART

U.S. Pat. Nos. 4,340,807 and 4,372,675 disclose the use of AC “cycle stealing” for precise control of power supplied to a xerographic fusing apparatus.

U.S. Pat. No. 5,826,152 discloses a fuser roll in which the heating elements are disposed within a hollow cylindrical tube inside the roll. Each heating element is independently controllable.

### SUMMARY OF THE INVENTION

According to one aspect of the present invention, there is provided a method of operating a fusing apparatus, the apparatus having a first heating element. An amount of power applied to the first heating element is incrementally changed in a series of power levels from zero power to full power, including at least two partial power levels, each power level being characterized by a number of periodically missing half-cycles relative to full power.

According to another aspect of the present invention, there is provided an electrostatographic printing apparatus, comprising a charge receptor for placing marking material relating to an electrostatic latent image on a print sheet, and a fusing apparatus for fusing the marking material on the print sheet, the fusing apparatus including a first heating element. Means are provided for incrementally changing an amount of power applied to the first heating element in a series of power levels from zero power to full power, including at least two partial power levels, each power level being characterized by a number of periodically missing half-cycles relative to full power.

### BRIEF DESCRIPTION OF THE DRAWINGS

FIG. 1 is a simplified elevational view showing the essential portions of an electrostatographic printer, such as a xerographic printer or copier, relevant to the present invention.

FIG. 2 is a plan sectional view of the fuser roll as viewed through the line marked 2-2 in FIG. 1.

FIG. 3 is a diagram of a method of changing the power applied to the lamps in the present invention.

FIG. 4 is a set of comparative waveforms showing the cycle stealing concept according to the present invention.

FIG. 5 is a schematic diagram showing one possible hardware implementation of the present invention.

### DETAILED DESCRIPTION OF THE INVENTION

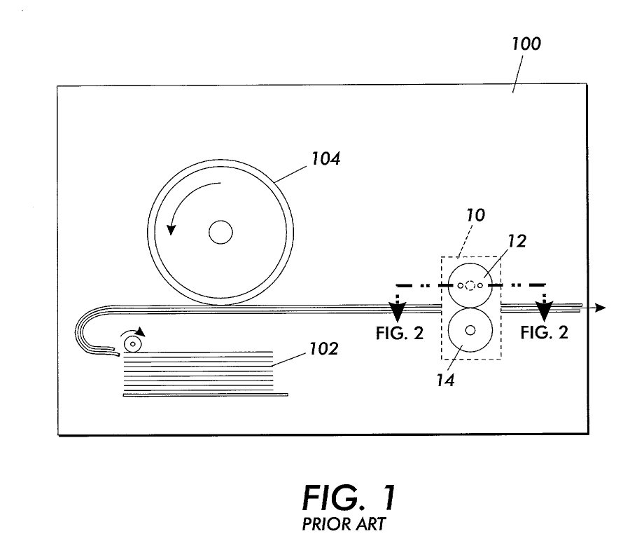

FIG. 1 is a simplified elevational view showing the essential portions of an electrostatographic printer, such as a xerographic printer or copier, relevant to the present invention. A printing apparatus 100, which can be in the form of a digital or analog copier, “laser printer,” ionographic printer, or other device, includes mechanisms which draw substrates, such as sheets of paper, from a stack 102 and cause each sheet to obtain a toner image from the surface of a charge receptor 104, on which electrostatic latent images are created and developed through well-known processes. Once a particular sheet obtains marking material from charge receptor 104, the sheet (now a print sheet) is caused to pass through a fusing apparatus such as generally indicated as 10. Depending on a particular design of an apparatus, fusing apparatus 10 may be in the form of a fuser module which can be removed, in modular fashion, from the larger apparatus 100.

A typical design of a fusing apparatus 10 includes a fuser roll 12 and a pressure roll 14. Fuser roll 12 and pressure roll 14 cooperate to exert pressure against each other across a nip formed therebetween. When a sheet passes through the nip, the pressure of the fuser roll against the pressure roll contributes to the fusing of the image on a sheet. Fuser roll 12 further includes means for heating the surface of the roll, so that heat can be supplied to the sheet in addition to the pressure, further enhancing the fusing process. Typically, the fuser roll 12, having the heating means associated therewith, is the roll which contacts the side of the sheet having the image desired to be fused.

Generally, the most common means for generating the desired heat within the fuser roll 12 is one or more heating elements within the interior of fuser roll 12, so that heat generated by the heating elements will cause the outer surface of fuser roll 12 to reach a desired temperature. Various configurations for heating elements have been discussed above with regard to the prior art. Basically, the heating elements can comprise any material which outputs a certain amount of heat in response to the application of electrical power thereto: such heat-generating materials are well known in the art.

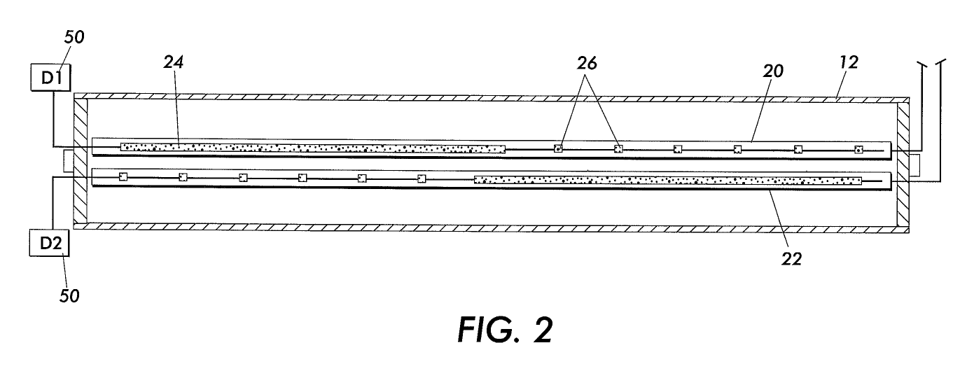

FIG. 2 is a sectional view of the fuser roll 12 as viewed through the line marked 2-2 in FIG. 1. FIG. 2 shows the configuration of heating elements in a fuser roll 12 according to a preferred embodiment of the present invention. As can be seen in the Figure, there is disposed within the interior of fuser roll 12 two “lamps,” meaning structures which incorporate heating elements, indicated as 20 and 22. The lamps 20 and 22 are each disposed along the axial length of the fuser roll 12, and as such are disposed to be largely perpendicular to a direction of passage of the sheets passing through the nip of the fusing apparatus 10.

As can be seen in FIG. 2, each lamp, such as 20, includes a specific configuration of heat-producing material, in this particular case, a relatively long major portion of heat-producing material 24, along with a number of smaller portions of heat-producing material, indicated as 26, all of which are connected in series. It will be noted that, within each lamp such as 20 or 22, major portion 24 is disposed toward one particular end of the fuser roll 12, while the relatively smaller portions 26 are disposed toward the opposite end of the fuser roll 12. In a practical embodiment, the heat-producing material substantially comprises tungsten, while the overall structure of the lamp is borosilicate glass: these materials are fairly common in the fuser-lamp context.

With reference to the claims below, it will be apparent that, with the illustrated configuration of heating elements within each lamp 20 or 22, each lamp 20 or 22 can be said to have a relatively hot and a relatively cold end. By this is meant simply that when electrical power is applied to either lamp (a lamp being considered a single heating element), one end of the lamp will largely generate more heat than the other end of the lamp. Other ways to express this can include the fact that the hot end reaches a higher temperature than the cold end, or that the hot end releases more heat per area on the outer surface of the fuser roll 12 than the cold end.

Further according to an embodiment of the present invention, the two lamps 20, 22 are disposed within the fuser roll 12 in parallel with each other, perpendicular to a direction of motion of sheets through the fusing apparatus, and further in a manner such that the relatively hot end of lamp 22 is adjacent the relatively cold end of lamp 20, and vice versa. Lamps 20, 22 should have substantially identical configurations of heat-producing material, and should be oriented in opposite directions, as shown.

In a preferred embodiment of the present invention, the two lamps 20, 22 are powered by separate circuits, each circuit with its own driver. Examples of drivers 50 are shown as D1, D2 in FIG. 2. At power up, power is applied by the respective drivers to each lamp in a “stair step” fashion; that is, at first a relatively low level of power is applied to the lamp, and this step level is maintained until the lamp is at a thermal equilibrium. After equilibrium is reached, a slightly higher power is quickly supplied to the lamp until once again a thermal equilibrium is reached, the process repeating until full power is reached.

In a practical embodiment, this power up cycle, from a cold start to full power suitable for fusing images, typically takes a few seconds: a typical range of time the system would place either lamp at a partial power level is 0.3 to 5 seconds for each partial power level up to full power. The time delay between “steps,” that is, between incremental increases or decreases in power, can be controlled by either a fixed routine or using some sort of feedback system. In general, the more tungsten in the lamp, the longer time is spent at each step level. Also, in a running condition, overheating detection at any point in operation will be typically answered with a slight temporary decrease in power applied to each lamp, this decrease generally being consistent with the “top step” in the power up cycle.

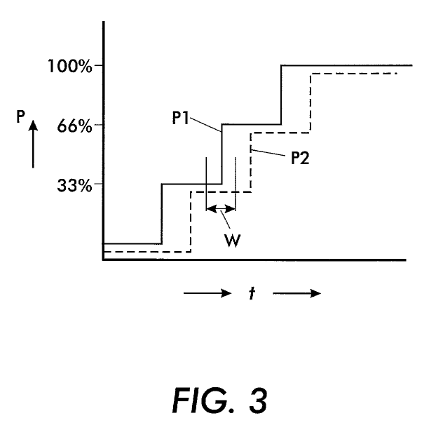

According to the illustrated embodiment, each lamp 20, 22 is independently powered in this stair step manner. Significantly, the software controlling power to each lamp is coordinated so that an increment or decrement in power to one lamp occurs only outside of a time window relative to a change in power to the other lamp. In other words, at power up, incremental increases in power to the lamps should occur out of phase. A diagram illustrating this out-of-phase stair step technique for power up is shown in FIG. 3: with P1 corresponding to the power to a first lamp and P2 corresponding to power to a second lamp over time t, it can be seen that any change (increase or decrease) in P2 must occur outside a time window of predetermined duration to a change in P1, yielding the desired “out-of-phase” effect. In another sense, it can be considered that for every change in P1, there should be provided a time-window W in which a change in P2 is not permitted. It has been found that this technique, particularly in conjunction with a fuser of the above-described configuration, is highly effective in reducing or eliminating the occurrence of flicker.

According to another aspect of the present invention, the various discrete power levels forming the “stair steps” of FIG. 3 are manifest by applying, to each lamp 20, 22 as needed, a sinusoidal voltage having partial cycles missing therefrom on a periodic basis, or in other words a “cycle stealing” principle. The missing cycles and half-cycles reflect applications of less than full voltage, so that, in the FIG. 3 case, partial power levels of 33% and 66% can be realized.

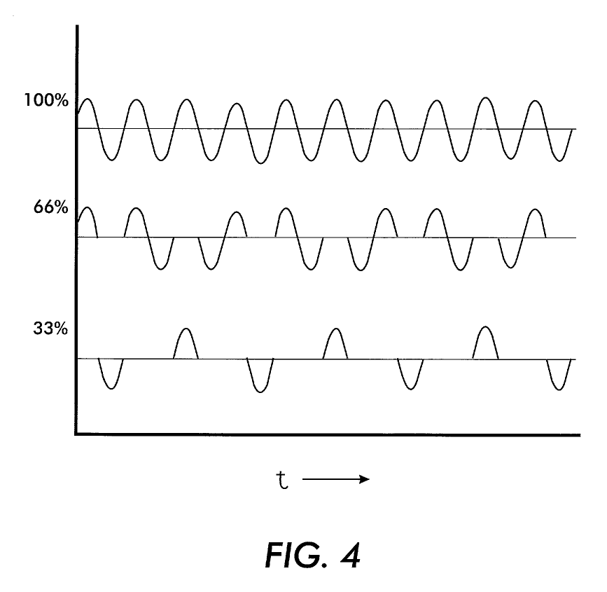

FIG. 4 is a set of comparative waveforms showing how, if a 100% power level applied to a lamp is manifest in the form of a full sinusoidal waveform, the lower levels are manifest by cycle stealing relative to the full waveform. The waveform marked 33% is the same as the 100% waveform except that, for two out of every three half-cycles, or lobes in the waveform over time, are in effect removed from the supplied voltage. For the 66% power level, as shown in the Figure, one out of every three lobes or half-cycles is missing. The missing half-cycles, in this embodiment, occur on a regular basis over time.

Also, comparing the 33% power level waveform to the 66% power level waveform, it can be seen that the missing lobes in the 33% waveform are evident in the 66% waveform, and vice-versa. This complementary feature of the two waveforms can apply to different power levels within the same lamp, or to power levels applied simultaneously to two lamps, such as in a power-up cycle.

Although the illustrated embodiment shows the discrete partial power levels in three steps, with one or two of every three half-cycles being missing, other embodiments could provide, for example, power up in two steps, with just one partial power level characterized by every other half-cycle missing; in four steps, with each of three partial power levels characterized by one, two, or three of every four half-cycles being missing; or other ways of achieving a desired number of partial power levels up to full power.

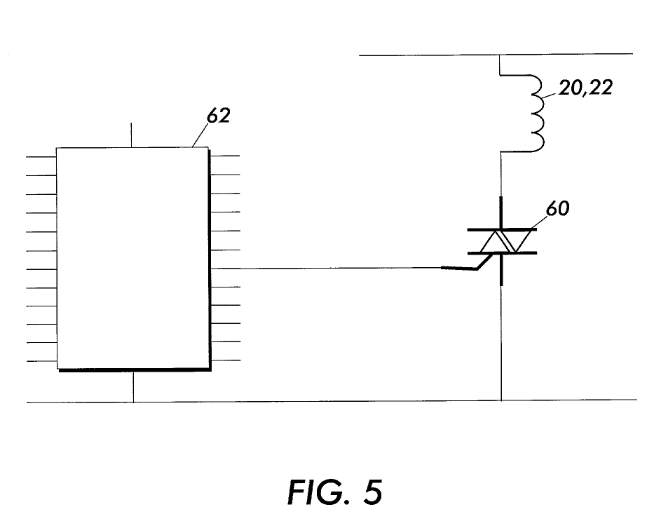

In order to create the cycle-stealing feature of the present invention, one possible technique is to use an optically isolated zero-crossing triac (opto-triac) in conjunction with a microprocessor or equivalent digital device. Such an arrangement is shown in FIG. 5: an opto-triac 60 is arranged in series with a lamp 20 or 22, and is switched by an output of microprocessor 62. Microprocessor 62 is enabled to accurately count each half cycle of the incoming mains cycles to achieve the desired cycle stealing; the counting process can be enabled by an input from a separate zero-crossing circuit (not shown). With the opto-triac 60, the following an applied gate turn-on optodiode current, the device cannot actually begin to conduct current to the lamp until the current has reached with a few volts of zero. Because there is no induction in the circuit, the current will follow the voltage sine wave profile. Since the opto-triac 60 is switched on at the zero cross position of the sine wave, the energy level of the system will be zero (or very low), which minimizes any temporary power surge, which would cause the undesirable flicker and also introduce undesirable harmonic current flow in the circuit that would otherwise occur. In short, using opto-triac 60 ensures that the applied voltage to the lamp 20, 22 is a pure sinusoid.

Although the above-described implementation shows cycle stealing and “stair step” power changes as applied to a two-lamp fuser, either or both principles can be applied to a single lamp fuser, or to any lamp or heating element associated with a fusing apparatus, such as in the case of a radiant fuser, a belt fuser, a lamp which is disposed on an outer surface of a fusing roll, etc. It will also be understood that the principles described herein relative to powering up a fusing apparatus can be applied, according to the invention, to powering down the apparatus, i.e., the principles for enabling the “stair steps up” shown in FIG. 3 can be used for a “stair steps down” operation.

1. A method of operating a fusing apparatus, the apparatus having a first heating element, comprising:
incrementally changing an amount of power applied to the first heating element in a series of power levels from zero power to full power, including at least two partial power levels, each power level being characterized by a number of periodically missing half-cycles relative to full power.

2. The method of claim 1, wherein, for a first partial power level, a periodic one of three half-cycles is missing.

3. The method of claim 2, wherein for a second partial power level, a periodic two of three half-cycles is missing.

4. The method of claim 1, wherein, for each partial power level, power is applied to the first heating element for 0.3 to 5.0 seconds.

5. The method of claim 1, wherein the fusing apparatus further comprises a second heating element, and further comprising the step of
incrementally changing an amount of power applied to the second heating element outside of a predetermined time window relative to incrementally changing the amount of power applied to the first heating element, including changing the amount of power applied to the second heating element in a series of power levels from zero power to full power, each power level being characterized by a number of periodically missing half-cycles relative to full power.

6. The method of claim 5, wherein each of the first heating element and the second heating element each have a relatively hot portion and a relatively cold portion.

7. The method of claim 6, wherein the first heating element and the second heating element are arranged whereby the relatively hot portion of the first heating element is adjacent the relatively cold portion of the second heating element.

8. An electrostatographic printing apparatus, comprising:
a charge receptor for placing marking material relating to an electrostatic latent image on a print sheet;
a fusing apparatus for fusing the marking material on the print sheet, the fusing apparatus including a first heating element; and
means for incrementally changing an amount of power applied to the first heating element in a series of power levels from zero power to full power, including at least two partial power levels, each power level being characterized by a number of periodically missing half-cycles relative to full power.

9. The apparatus of claim 8, wherein the means for incrementally changing an amount of power applied to the first heating element includes an opto-triac.

10. The apparatus of claim 8, wherein, for a first partial power level, a periodic one of three half-cycles is missing.

11. The apparatus of claim 10, wherein for a second partial power level, a periodic two of three half-cycles is missing.

12. The apparatus of claim 8, wherein, for each partial power level, power is applied to the first heating element for 0.3 to 5.0 seconds.

13. The apparatus of claim 8, further comprising
a second heating element, and
means for incrementally changing an amount of power applied to the second heating element outside of a predetermined time window relative to incrementally changing the amount of power applied to the first heating element, including changing the amount of power applied to the second heating element in a series of power levels from zero power to full power, each power level being characterized by a number of periodically missing half-cycles relative to full power.
